(19) United States
(12) Patent Application Publication
(10) Pub. No.: US 2006/0283557 A1
(43) Pub. Date: Dec. 21, 2006

(54) Curtain for a container, and container therewith

(76) Inventor: Petra Van Neck, Gent (BE)

Correspondence Address: HARNESS, DICKEY & PIERCE, P.L.C., P.O. BOX 828, BLOOMFIELD HILLS, MI, 48303, US

(21) Appl. No.: 11/314,950

(22) Filed: Dec. 21, 2005

(30) Foreign Application Priority Data
Jun. 20, 2005 (DE) 10 2005 028 708.5

(51) Int. Cl. E06B 3/48; B65D 25/54

(52) U.S. Cl. 160/113; 206/774

(57) ABSTRACT

The present invention concerns a curtain for an open side of a container, and the container having such a curtain, wherein the curtain comprises a flexible web material, is of an approximately rectangular shape and can be connected along its upper edge to the portion of the container, which is in opposite relationship to that upper edge. In accordance with the invention, the lower left and right corner regions of the curtain are on average per unit of surface area of a greater weight than the average of the remaining areas of the curtain. This allows the curtain to close automatically and independently in a well-defined manner and in so doing completely covers over the front side of the container without a user having to actively intervene apart from pulling down the curtain from the top side of the container or allowing the raised curtain to fall.

### CROSS-REFERENCE TO RELATED APPLICATIONS

This application claims the benefit of German Serial No. 10 2005 028 708.5, filed Jun. 20, 2005.

### FIELD OF THE INVENTION

The present invention concerns a curtain for an open side of a container, wherein the curtain comprises a flexible web material, is of an approximately rectangular shape and can be connected along its upper edge to the portion of the container, which is in opposite relationship to that upper edge. The present invention concerns a curtain for an open side of a container, wherein the curtain comprises a flexible web material, is of an approximately rectangular shape and can be connected along its upper edge to the portion of the container, which is in opposite relationship to that upper edge.

### BACKGROUND

Corresponding curtains are known inter alia from various transport containers as are used for example for transporting automobile parts in the automobile industry. Parts of an automobile (private car or heavy goods vehicle) are produced by suppliers and delivered in just-in-time relationship with the planned fitment to a vehicle, to a corresponding factory or assembly line of an automobile manufacturer. For that purpose the corresponding parts are generally contained in large containers which in turn have a multiplicity of compartments in which the respective automobile parts in question are individually accommodated in protected fashion. The parts are transported in those containers and the containers are set down directly in the immediate proximity of the corresponding assembly belt so that the assembly personnel can remove the parts directly from the container and fit them to a vehicle.

In that situation the parts are often accommodated in individual compartments of a container, which comprise a flexible web material so that the various parts which are often delicate or have projecting sharp edges or corners do not directly come into contact with each other. For ease of removal of the parts however those compartments are open towards at least one side of the container. One or each such side corresponds for example to the above-mentioned open side of a container, in which respect there is no need to consider whether, for example for the transport of corresponding containers, a fixed flap or a cover for that open side or sides is or are also additionally provided. For the sake of simplicity that open side is referred to hereinafter as the ‘front side’ as this generally involves the side which is towards a user, even if the present invention self-evidently also includes any corresponding curtain which is provided for any open side.

In order to protect the parts during transport and in particular to prevent dust from getting into the container or the individual compartments, open front sides of that kind are sometimes provided with a curtain which hangs down loosely at the front side of the container and which therefore closes that open front side of the container sufficiently tightly to protect the parts accommodated in the container from environmental influences.

It will be appreciated that, to take out the individual parts, the curtain must be moved away from that open front side. That is generally effected by folding the curtain up over its upper edge and on to the top side of the container, at least when the upper edge of the curtain is also fixed to the container in the proximity of the upper edge thereof. Depending on the respective size of the container however that operation can be relatively difficult to carry out so that from time to time it is only successfully possible to fold back a part of the curtain on to the top side of the container or, after a part of the curtain has been folded up, the rest is simply pushed in some manner from below upwardly on to the top side of the container and lies there piled up uncontrolledly at the edge. In that situation it can happen that such a curtain also unintentionally slips back down again and assumes a position in front of the open front side of the container.

The container can moreover have closed side walls (including the rear wall) and/or a closed bottom and a closed top side, and possibly the side walls, the bottom and also the top side can be open and the container can in other respects consist of a frame in which the compartments are suspended in the form of an interconnected insert. In that case the outsides of the compartment divisions effectively form the side walls or the top side and/or the underside of the container, in which respect, as will be appreciated, hybrid forms are a possibility, in which case for example the bottom has an additional closed wall while the side walls and/or the top side are in principle open, but there the outside walls of the compartment inserts effectively form a side wall and/or an upper wall or rear wall respectively. Often however the rear side is open in the same manner as the above-mentioned front side and in that respect is equally to be viewed as the ‘front side’ after the container is turned around through 180° or if the user approaches it from the other side. The same possibly applies to the other side walls.

It will be appreciated that it is irksome if a curtain which has been turned back on to the top side, in use of the corresponding container, say when removing articles from the container or also when loading the arrangement with corresponding articles, under some circumstances uncontrolledly slips down again and thereby at least partially covers the front side or the front openings of the individual compartments.

On the other hand it may however be that parts are only removed from the container from time to time or, for example in the case of a possibly expensive production of articles, they are put into the compartments of the container only at relatively great time intervals so that it is desirable for the curtain to be kept closed in the meantime in order to protect the articles which are already or still in the container, from external influences. In that case for example the curtain is opened for the respective operation of introducing or removing an individual article or just a few articles, and is thereafter closed again.

When closing the curtain it is in turn important that the curtain completely closes the open side of the container and as far as possible has no folded-over corners or folds which leave open a part of the compartments which are open towards that side and in which corresponding articles may still be or are already disposed. In the case of the previously known curtains of that kind however that means that the user is required not just to simply let down the curtain after it was folded back for example on to the top side, but he must ensure in that respect that the curtain does not form any folds and is not turned back at its edges but completely covers over the front side of the container. For that purpose it is often necessary for the user to eliminate corresponding folds or turned-back edges by grasping the outer edges of the curtain and pulling them into their desired position.

### SUMMARY

In accordance with an aspect of the invention, a curtain for a container which when suitably fitted on the one hand can be folded back on to the top side of a container in a well-defined manner and which otherwise, when being folded back or pulled down from the top side respectively, for that purpose closes automatically and independently in a well-defined manner and in so doing completely covers over the front side of the container without for that purpose the user having to actively intervene apart from pulling down the curtain from the top side of the container or allowing the raised curtain to fall. In accordance with an aspect of the invention, the foregoing is achieved in that the two lower left and right corner regions of the curtain are on average per unit of surface area of a greater weight than the average of the remaining areas of the curtain. In an aspect, a container has such a curtain.

When a user grasps such a curtain, typically near the centre of the lower edge thereof, the lower left and right corner regions of the curtain hang down to the left and the right of the point at which the curtain is gripped, that being still further intensified in particular by the increased weight of the corner regions. In that case fold lines are formed substantially from the upper right and left corners of the curtain, to the point where the curtain is gripped and raised by the user. The lower left and right corner regions hang loosely downwardly from those fold lines, in a slightly curved arc. If the user simply releases the curtain in that position so that it drops down, then its heavier lower left and right corner regions firstly have a tendency to close more quickly than the remaining part of the curtain, but, due to the air resistance which occurs in that case or the draught produced thereby, they also swing back in part as in a wave similarly to the wings of a bird or, to put that in better form, like wings or lateral, wing-like fins of a ray, so that the air behind the curtain can escape and the curtain assumes a position in a smooth condition and without fold formation in front of the open side of the container and completely covers it over.

When laying down the curtain on the top side of the container of the frame the curtain is desirably laid down in a manner corresponding to the folds which form when it is lifted up. When the curtain is also pulled down from the top side of the container and allowed to fall the curtain according to the invention assumes a position, with a corresponding ‘wing beat’, in a smooth condition in front of the open side of the container.

It will be appreciated that, in spite of the reference to the upper edge and the upper right and left corners, the curtain does not necessarily have to be of an exactly rectangular configuration but for example the upper edge can be curved or kinked in the manner of a gable, in which case also the lower corner regions do not have to be corner regions of an exact rectangle but for example can also have greatly rounded corners. The only essential consideration is that the upper edge of the curtain is fixed in some manner to the container and that the curtain can be folded over along that fixing line or also along a line parallel thereto and can be set down on the upper surface of the container insofar as it is to be set down on the surface at all.

The folds which are produced when lifting the curtain and when laying it down on the top side can be influenced by pivoting the lower central portion firstly towards the one side and then towards the other side when laying down the curtain on the top side of the container so that the curtain also lies in that state in a neatly folded configuration on the top side of the container.

Even if however it is not possible for the curtain to be laid down on the top side of a container because for example the container is too high for a user to be able to reach the top side with his hands, the curtain according to the invention can nonetheless be advantageously used, with the described features, because the curtain can also be held up with one hand for a short time, for the removal of individual articles. After an article has been removed (or introduced), then the user simply releases the curtain so that it falls back, in which case the two, loosely downwardly hanging left and right lower corner regions open like two wings and close again towards the open container in the manner of a wing beat motion. That is of particular interest in relation to embodiments or containers from which articles are removed only from time to time (or similarly introduced thereinto) and which moreover are exposed for example to rough environmental conditions (dust, cuttings, rain, spray water, chemicals).

In accordance with an embodiment of the present invention the lower corner regions can have some weights, wherein those weights can be concentrated along the lower edge and/or also the right and left side edges, but should preferably be distributed uniformly over the surface of the lower right and left corner regions.

A preferred embodiment of the invention however is one in which the lower corner regions have triangular surfaces of increased weight per unit of surface area, for example in the form of thickenings of the web material, which in turn preferably make up in each case at least 10% and preferably more than 15% of the area of the overall curtain.

It is desirable for example if the lower left and right corner regions comprise a larger number of layers of the flexible web material than the greatest part of the remaining area of the curtain.

In this connection it is to be noted that the multi-layer corner regions do not mean for example folded-over seams at the edges of the curtain but rather regions of large area, which extend in the direction of the centre of the curtain and which are not just limited in the manner of a seam to the regions of the edges. As already mentioned the multi-layer or double-layer lower left and right corner regions should each make up at least about 10% of the curtain area. Even insofar as reference is made to the ‘remaining curtain areas’, that means the areas within the regions enclosed by any edge seams.

In general a preferred variant of the invention is one in which the lower left and right corner regions are homogeneous, that is to say are of a uniform surface density, in which respect in this case also once again any seams along the edge are to be disregarded. Homogeneity of the corner regions is automatically afforded if the corner regions are formed by two or more layers of the flexible web material constituting the curtain while the remaining curtain areas have only one layer or fewer layers than the left and right lower corner regions. It will be appreciated that it is assumed in that respect that the flexible web material or the individual layers thereof is or are otherwise of a substantially uniform thickness.

In a particularly preferred embodiment of the present invention the lower left and right corner regions respectively embrace substantially the entire area which is enclosed by the left or right edge respectively, the lower edge and a line which extends from the upper left and right corner respectively of the curtain to the centre of the lower edge, or to a point on the vertical longitudinal centre line of the curtain above the lower edge, but preferably still within the lower half of the curtain, in the latter case the area of increased specific weight in relation to area assuming the shape of an oblique-angled right-angled trapezium as is also defined inter alia by claim 8.

In addition a particularly preferred embodiment of the present invention is one in which, starting from the proximity of the lower edge, to stiffen a central lower portion of the curtain, a bar comprising a material which is stiff in relation to the material of the curtain extends approximately along the vertical longitudinal centre line to a point within the lower half of the curtain.

That bar which is fixed to the curtain at least in the proximity of the lower edge thereof and to a further point within the lower half of the curtain and which stiffens the curtain in that central portion possibly serves not only as a stiffening element but at the same time as a handle and, when the curtain is being opened, can be gripped by a user and can be set down upwardly on to the top side of the container. As the bar is of a certain length and its lower portion which is in the proximity of the lower edge can be at any event reached and gripped with one hand so that at least that lower portion can be pushed over the upper front edge of the container, at the same time it also pushes the portion of the curtain which is disposed thereabove and which is fixed to the other upper end of the bar on to the top side of the container.

In that case the fold lines are formed by a connection of the upper left and right corner regions of the curtain to the lower fixing point of the bar in the proximity of the centre of the lower edge, more specifically if the bar is held substantially in the plane of the curtain or however if the bar is angled in relation to the plane of the curtain, to the upper fixing point of the bar.

By virtue of the arrangement and manner of mounting that bar, even in the case of relatively high containers, the top side of which can still just be reached by a user with his hands, it is nonetheless possible to set down the curtain securely on the top side of the container without it being able to slip off. In that respect the bar helps to push the upper portions of the curtain sufficiently far on to the top side of the container and, after it has been laid thereon, the lower end of the bar can terminate substantially with the upper front edge of the container, in which case also substantially the entire lower edge of the curtain is pushed up on to the top side of the container or overhangs it only slightly.

For the purposes of the original disclosure it is pointed out that all features as a man skilled in the art will infer from the present description, the drawings and the claims, even if they were described specifically only in conjunction with certain further features, can be combined both individually and also in any combinations with others of the features or groups of features disclosed herein, unless that has been expressly excluded or technical aspects make such combinations impossible or meaningless. It is only for the sake of brevity and readability of the description that a comprehensive and explicit representation of all conceivable combinations of features is foregone herein.

That applies in particular but not just in regard to the above-mentioned bar, in which respect it will be appreciated that such a bar can also be appropriately fitted to a curtain if the left and right lower corner regions are not heavier per unit of area than the rest of the curtain. Advantages are also enjoyed then, in particular when the curtain is laid down on the top side of the container and also when pulling it down therefrom.

### BRIEF DESCRIPTION OF THE DRAWINGS

Further advantages, features and possible uses of the present invention will be apparent from the description hereinafter of a preferred embodiment and the accompanying Figures in which:

FIG. 1 is a diagrammatic view of a portion of a container with a closed curtain according to the invention,

FIG. 2 shows the container and curtain of FIG. 1 with a partially lifted curtain,

FIG. 3 shows the container of FIG. 1 with a curtain folded partially back on to the top side, and

FIG. 4 shows the container of FIG. 1 with a curtain laid down completely on the top side of the container.

### DETAILED DESCRIPTION

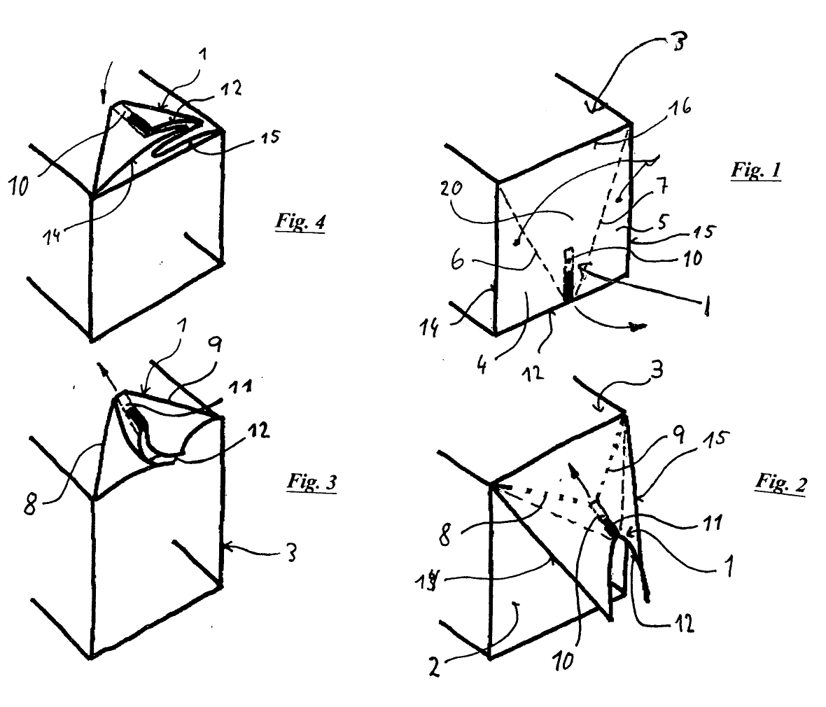

Referring to FIG. 1 shown therein is a container 3 which is only partially illustrated diagrammatically in the form of a broken-away box and which is substantially in the form of a parallelepiped, that is to say it has an underside and a top side as well as peripherally extending side walls of which one defines a front side which is shown in FIG. 1 as being closed by a curtain 1. That curtain comprises a flexible web material and is of a substantially rectangular shape which is adapted to the shape of the front side of the container 3. The curtain 1 is connected along its upper edge 16 to the upper edge of the container 3. The front surface extends substantially vertically, in which respect it will be noted however that the invention would also function in the same manner if for example the front surface were to extend in a slightly inclined plane and the upper edge of the container would therefore be set back inwardly somewhat in relation to the lower edge.

The curtain has a left lower corner region identified by reference 4 and a right lower corner region identified by reference 5, which are delimited from the remaining curtain area by broken lines 6 and 7 respectively. Those broken lines 6, 7 extend from the left and right upper corners of the curtain respectively approximately to the centre of the lower edge 12 of the curtain, in which respect it will be noted that those lines 6, 7 however do not necessarily have to extend precisely straight and moreover can also be slightly displaced with respect to the illustrated positions. The left and right lower corner regions 4, 5 differ from the upper central region 20 which extends substantially between the lines 6, 7 and the upper edge 16, by virtue of the fact that the regions 4, 5 are of greater weight per unit of surface area than the central region 20 and in particular comprise more layers of the flexible web material than the central region 20. In specific terms here the regions 4, 5 are made from two layers of the web material while the central region 20 comprises only one layer of the same material (once again without having regard to any edge seams). For that purpose suitable triangular web portions of the flexible material, which correspond to the shape of the regions 4 and 5, are sewn on to a rectangular web corresponding to the overall curtain surface, for example along the lines 6, 7 and along the lower edge 12 and the left and right edges 14, 15 of the curtain. It will be appreciated that those additional webs can also be glued on or welded on, depending on the respective nature of the flexible web material constituting the material of the curtain.

Also disposed in the lower region of the curtain and arranged substantially along the vertical centre line of the curtain is a bar which in the present case is a metal rail 10 which is sewn to the curtain 1 (for example by way of corresponding holes in the metal rail). As will be seen that metal bar 10 extends approximately from the centre of the lower edge 12 of the curtain to approximately a third of the total height of the curtain 1. Preferably the upper fixing point of that bar 10 should still be within the lower half of the curtain while the lower fixing point should preferably be in the proximity of the lower edge, that is to say within the lower 10% of the height of the curtain.

In addition the lower portion of the bar 10 can also be provided with a handle 11 which makes it easier to hold the bar and the curtain 1.

FIG. 2 shows the curtain 1 in the partially lifted condition, wherein that condition is afforded for example by a user gripping the handle 11 and pulling it forwardly and upwardly. By virtue of their double-layer nature the lower left and right corner regions 4, 5 are relatively heavy and hang loosely down, in which case, depending on the respective orientation of the stiffening bar or the metal rail 10, they form one or two bend lines which are defined by the lines 8, 9 and 6, 7 respectively. If the metal rail 10 is held substantially in the plane corresponding to the curtain portion which is disposed thereabove and which is held in a taut state, the bend line is defined rather by the lines 6, 7 while in contrast if the metal rail 10 is angled downwardly with respect to the plane of the curtain which is thereabove, that rather involves a bend along the lines 8, 9, wherein the term ‘bend’ here does not mean a sharp line but a more or less rounded transition from the flat surface which is above the metal rail 10 to the downwardly hanging left and right lower corner regions 4, 5 which are accordingly of a triangular or trapezoidal shape.

FIG. 3 shows how the rail 10 is now lifted by means of the handle 11 above the upper edge of the container. In that case a bend or a fold line is formed along the respective ones of the lines 8, 9, as has already been described hereinbefore with reference to FIG. 2. The lower left and right corner regions 4, 5 then substantially only hang down from the rail 10 and the user can then lay down the curtain overall in a folded form on the top side of the container 3, as is finally shown in FIG. 4.

To pull the curtain down from the top side of the container the user preferably grips the handle 11, pulls it forwardly over the upper edge 16 and simply allows the curtain to drop, in which case the curtain assumes a position in a smooth condition and completely in front of the open side of the container, by virtue of the specific configuration described.

It will be appreciated that the accompanying Figures only diagrammatically show the subject of the invention, while parts which are not essential for the invention such as for example the internal compartmentalisation of the container 3 and a complete illustration of the container 3 have been omitted.

What is claimed is:

1. A curtain for an open side of a container, the curtain comprising:
a. a flexible web material of an approximately rectangular shape that is connected along an upper edge to a portion of the container; and
b. the curtain having lower left and right corner regions that are on average per unit of surface area of a greater weight than the average of the remaining areas of the curtain.

2. A curtain according to claim 1 wherein the lower corner regions of the curtain have weights affixed thereto.

3. A curtain according to claim 1 wherein the lower corner regions include thickenings of the flexible web material to provide the greater weight of the lower corner regions.

4. A curtain according to claim 3 wherein the lower corner regions include a larger number of layers of the flexible web material than a greatest part of the remaining areas of the curtain.

5. A curtain according to claim 4 wherein the lower corner regions include two layers of the flexible web material while the remaining areas of the curtain include substantially one layer of the flexible web material.

6. A curtain according to claim 5 wherein each of the lower corner regions of increased weight in relation to the remaining areas of the curtain makes up at least about 10% of the total curtain area.

7. A curtain according to claim 6 wherein the corner regions have a uniform density in relation to area.

8. A curtain according to claim 7 wherein the lower corner regions include substantially an entire area which is defined by left and right corners of the curtain and lines which extends from the upper left and right corners, respectively, of the curtain to a longitudinal center line in proximity of or above a lower edge of the curtain, at a maximum to half a height of the curtain.

9. A curtain according to claim 8 wherein at least a portion of the curtain is transparent plastic material.

10. A curtain according to claim 9 including a bar of stiff material is fixed to the curtain so that it extends along a vertical center line of the curtain from a lower edge of the curtain to a point within a lower half of the curtain.

11. A curtain according to claim 1 wherein each of the lower corner regions of increased weight in relation to the remaining areas of the curtain makes up at least about 10% of the total curtain area.

12. A curtain according to claim 1 wherein the corner regions have a uniform density in relation to area.

13. A curtain according to 1 wherein the lower corner regions include substantially an entire area which is defined by left and right corners of the curtain and lines which extends from the upper left and right corners, respectively, of the curtain to a longitudinal center line in proximity of or above a lower edge of the curtain, at a maximum to half a height of the curtain.

14. A curtain according to claim 1 wherein at least a portion of the curtain is transparent plastic material.

15. A curtain according to claim 1 including a bar of stiff material is fixed to the curtain so that it extends along a vertical center line of the curtain from a lower edge of the curtain to a point within a lower half of the curtain.

16. A container, comprising:
an open side;
a curtain having an upper edge affixed to the container at an upper edge of the open side of the container; and
the curtain having weighted lower left and right corner regions so that an average per unit of surface area weight of the lower corner regions is greater than an average per unit of surface area weight of a remaining portion of the curtain.

17. The container of claim 16 including weights affixed to the lower corner regions.

18. The container of claim 16 wherein the lower corner regions are substantially triangular or trapezoidal regions.

19. The container of claim 16 wherein the curtain includes a flexible web material, the lower corner regions having more layers of the flexible web material than the remaining portion of the curtain.

20. A container according to claim 16 wherein each of the lower corner regions of the curtain of increased weight in relation to the remaining areas of the curtain makes up at least about 10% of total curtain area.

21. A container according to claim 16 wherein the corner regions of the curtain have a uniform density in relation to area.

22. A container according to 16 wherein the lower corner regions of the curtain include substantially an area which is defined by left and right corners of the curtain and lines which extends from the upper left and right corners, respectively, of the curtain to a longitudinal center line in proximity of or above a lower edge of the curtain, at a maximum to half a height of the curtain.

23. A container according to claim 16 wherein at least a portion of the curtain is transparent plastic material.

24. A container according to claim 16 including a bar of stiff material fixed to the curtain so that it extends along a vertical center line of the curtain from a lower edge of the curtain to a point within a lower half of the curtain.
